(19) United States
(12) Patent Application Publication
(10) Pub. No.: US 2006/0020884 A1
(43) Pub. Date: Jan. 26, 2006

(54) Method and system of web site construction

(76) Inventor: Peter John Graham, Victoria (AU)

Correspondence Address: SEYFARTH SHAW LLP, 55 EAST MONROE STREET, SUITE 4200, CHICAGO, IL, 60603-5803, US

(21) Appl. No.: 10/536,820

(22) PCT Filed: Jan. 6, 2004
(86) PCT No.: PCT/AU04/00006

§ 371 Date: May 27, 2005

(30) Foreign Application Priority Data
Jan. 6, 2003 (AU) 2003900055

(51) Int. Cl. G06F 17/21; G06F 15/16

(52) U.S. Cl. 715/517; 715/513; 709/203

(57) ABSTRACT

A method and apparatus for providing a web site, the method comprising: hosting a web site on a web server, the web site having at least one template page defined by a template, the template defining how content should be assembled into a page by a client's browser; the web server receiving a request for a template page from a client computer; the client's browser ascertains a content identifier on the basis of the request and sends the content identifier to a content server; the content server searching records of the content server to locate a set of content associated with the content identifier, formats it, and sends the set of content to the client.

### FIELD OF THE INVENTION

The present invention relates generally to a method and apparatus for providing a web site.

### BACKGROUND OF THE INVENTION

In the past many businesses have invested in a web site believing it will generate new business, streamline processes, replace promotional literature, or provide better levels of client or customer service.

Very large organisations and government departments may attain these objectives but at a considerable cost with respect to the purchase of software and the human resource required in the form of highly skilled and experienced operators. However, for smaller businesses these objectives have rarely, if ever, been attained and many sales organisations have failed to achieve the promised advantages of having a web site integrated into their marketing and sales plans.

The reason for this failure is usually due to the web site owner's inability to immediately and easily alter the content on their site. Normally they must invest in specialist software, such as DreamWeaver, or employ the costly expertise of an independent web development service. Currently, if a web site owner requires the content of his web site altered, a combination of expertise, software, time, delay, and training are all required. The resultant cost of such a process generally ends in reduced amendments to web site content and as such, many web sites do not remain current with respect to the information displayed.

This situation is often evidenced by the fact that Newsletters are not altered after the initial ‘rush’, with the last showing an ‘update date’ many months, if not years, prior to the current date.

Adding services such as e-commerce, running applets, or incorporating an Intranet to a site have provided tools for helping businesses get more from a web site but these require even more expertise to operate properly.

In some instances a database structure is linked to a web site adding more flexibility but also more cost and complexity, both the database and web site are generally hosted in the same domain space. This combination has led to a large number of self-contained sites making their usage and development even more dependent on costly expertise.

Despite several attempts to make web sites a more useful tool the situation has become worse. Today it's almost universal to use the same web site generation and maintenance methods of the past, namely, outside expertise using specialist software to create the html files needed to create the image and to carry the content of a web site. The html files are usually stored in the web site owner's domain space and require individual maintenance if they are changed. Though databases have added flexibility to content of late, this trend has further reduced the ability of web site owners to control the content of their web sites without substantial expenditure in the form of time, effort and cost.

One previous attempt to solve this problem involves a ‘wizard’ based system where the web site owner is given access to a construction and administration system that creates a file based web site via the ‘dragging, dropping and populating’ of fields. When this is done the html script and files are automatically generated which in turn create the web site. Such a system usually maintains the entire site on a central server which usually means that the site's URL is not that of the web site owner but usually one within a master domain. This approach effectively provides an automated ‘specialist software’ system, and is based on creating Pages from stored html files, the content of which the web site owner can vary. However, such an approach continues to require the skills and expertise of a relatively highly skilled operator, and systems provided commercially using this approach are often considered too complex to use given existing levels of business in-house expertise.

None of the previous attempts is known to have overcome the current problems of web site development costs, of on-going costs, of the inability for content management by low skilled and/or inexperienced personnel, or to have addressed businesses' need to have a web site that can be easily integrated into their marketing and sales strategies.

Any discussion of documents, devices, acts or knowledge in this specification is included to explain the context of the invention. It should not be taken as an admission that any of the material forms part of the prior art base or the common general knowledge in the relevant art on or before the priority date of the claims herein.

### SUMMARY OF THE INVENTION

The present invention provides a method of providing a web site comprising:
hosting a web site on a web server, said web site having at least one template page defined by a template, said template defining how content should be assembled into a page by a client's computer and including at least one content identifier corresponding to electronic content stored on a content server;
said web server receiving a request for a template page from a client computer;
said web server responding to said request by sending said template to said client computer;
said client computer ascertaining said content identifier from said template;
said client computer sending a content request to said content server according to said content identifier;
said content server receiving said content request and responding by searching records of said content server to locate content associated with said content identifier and sending said content to said client computer;
said client computer assembling at least one page in accordance with said template and including said content and displaying said page.

The present invention also provides an apparatus for providing a web site comprising:
a content server; and
a web server hosting a web site, said web site having at least one template page defined by a template, said template defining how content should be assembled into a page by a client's computer and including at least one content identifier corresponding to electronic content stored on a content server, said web server being configured to receive a request for a template page from a client computer and in response to send said template to said client computer;
wherein said content server has records containing electronic content and is configured to receive a request from said client computer for the content associated with said content identifier and in response to search said records to locate said content and send said content to said client computer;
whereby said client computer can assemble at least one page in accordance with said template and including said content and then display said page.

### BRIEF DESCRIPTION OF THE DRAWINGS

In order that the present invention may be more clearly ascertained, a preferred embodiment of the invention will now be described, by way of example, with reference to the accompanying drawings, in which:

FIG. 1 is a diagrammatic representation of an apparatus according to a preferred embodiment of the present invention;

FIG. 2 is a view of a web site constructed by means of the apparatus of FIG. 1 when viewed by means of a web browser (in this figure Internet Explorer);

FIG. 3 is an example of a prior art site where displayed content is from stored html files and is static in nature; and

FIG. 4 is a flow chart of the steps involved from start to finish of a web site constructed using this preferred method.

FIG. 5 is a view of a web site constructed with multiple content identifiers/modules as indicated by the header addresses.

### DETAILED DESCRIPTION OF A PREFERRED EMBODIMENT

In the preferred embodiment of the present invention, and unlike a prior art web site, the content of the web site is stored as records in a central associative database rather than as a static html or similar file/record in the web site owner's own webserver space. As explained in more detail, the content is called when a url containing the required content identifier is loaded by the client browser (either when the site's template is loaded or a subsequent menu item selected), the content server receives this request, a script running on the content server organises related records and converts them into a layout and format a Browser can display, this data is delivered to the site itself and displayed in the area designated by the site's image template. The records stored in this central database (and hence the content) can easily be changed by the site owner, which makes changing such content easier than in prior art arrangements where the owner of the web site generally must wait for expensive in-house expertise or a third party to implement any changes. In this embodiment, the only component which requires technical expertise of the type noted is the template page and its associated files/records.

A web site developed in this way allows changes to be made immediately and easily by non-expert staff, and accordingly it becomes a true communication tool, just like a letter, flyer or brochure. As distinct from a conventional site, such a web site can become the primary means an entity has for saying who it is, what it does, what's sold, whom they supply or sell through, their range of products and services, and can be used for the very rapid introduction of any new product or service. This construction method can also make content identified by a chosen content identifier private and secure, so that it requires a client specific user ID and Password for access.

For example, when a new product is released the Sales Manger's department can now add information, more easily and without specialist software or expertise, about the product to the Site because little technical expertise is required; the Sales Manger's department can thereby make that information immediately available to the public and/or a distribution chain. In this way products can be released sooner; sales staff can use the site to sell immediately and without having to wait for promotional literature; the entire distribution system knows of this information immediately; and all clients can start ordering straight away rather than having to wait for sales staff. For smaller companies in particular, this permits the virtual launch of a product or service to be a reality for the first time without requiring outside help or significant internal expertise. A conventional site can not offer this ease, speed, or cost efficiency.

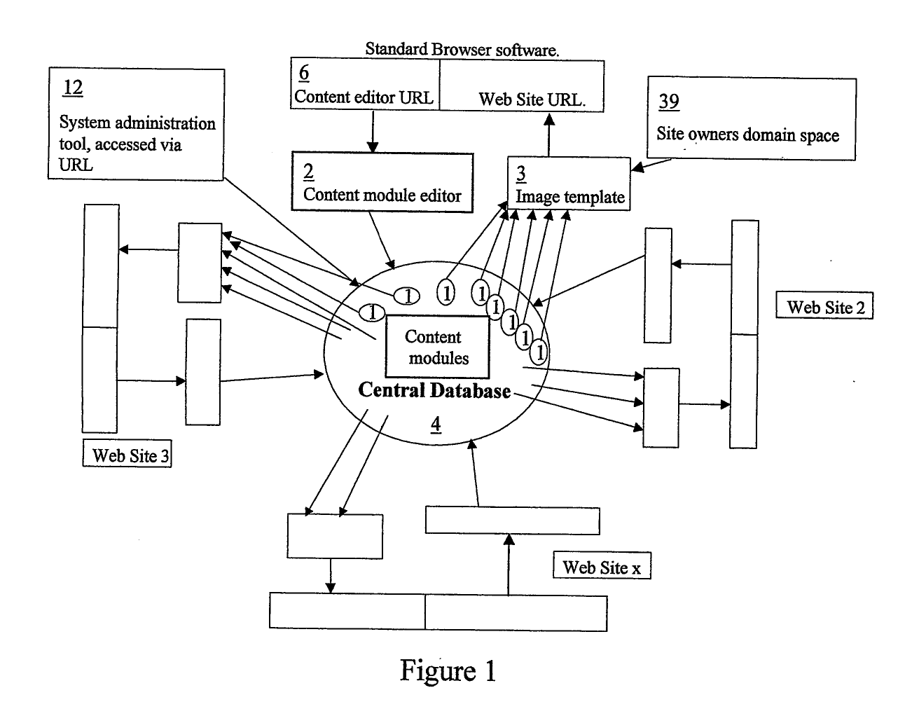

Referring now to the accompanying Figures, FIG. 1 shows that in the apparatus of the preferred embodiment there is provided a central associative database 4 stored on a content server, where two main tables control all client and content identification, and which enables the content server to act as a content manager for a plurality of sites. The associative database may be an SQL or equivalent database. The main tables in this central database 4 manage the identification process of a web site owners content. The content is stored as one or more sets of content known as content modules 1, each with its own content identifier, into which the site owner enters content. Each content module consists of one or more records (articles), each having its own identifier but all associated with the content module identifier, which, in turn, contain product information or the like. Thus, each content module is identified by a content identifier and has one or more associated records (articles) that the web site owner has added.

A web site has no content unless at least one content identifier/module is purchased, leased or rented and associated with it, and that content identifier/module in turn has no content unless the web site owner has added one or more ‘articles’.

A ‘content module’ 1 identifier is generated by the system's administration tool 12 when a new web site owner is added to the system, or an existing web site owner purchases, rents or leases further content modules for ‘bolting-on’ to their web site. The web site owner then uses that identifier to access URL based editing tools 2 to add records (articles) to a content module 1. Content modules and related records (articles) are controlled by tables within the central database 4.

In response to a request from a client (usually a user computer running browser software), the web server sends a template/index file which the client loads. This creates the look and image of the site and contains one or more content identifier URLs, usually as part of the menu structure, though a content module can be loaded when the template itself loads. If a content module is to be loaded immediately or subsequently via a menu structure, then the client sends such requests in the form of a URL directly to the content server, which activates the central database management program that collects, and formats, the associated content and sends it directly to the client for display in the template. In the preferred embodiment the content server formats the content into a portion of html which the client computer assembles into a page by inserting it in the template format into a reserved area of the template page. The template page is the basic web site structure that gives a professional look and feel to the site. It contains no content per se, but calls and displays content modules 1 when required.

A web site constructed under this method usually obtains all product, service and business related content from content modules 1.

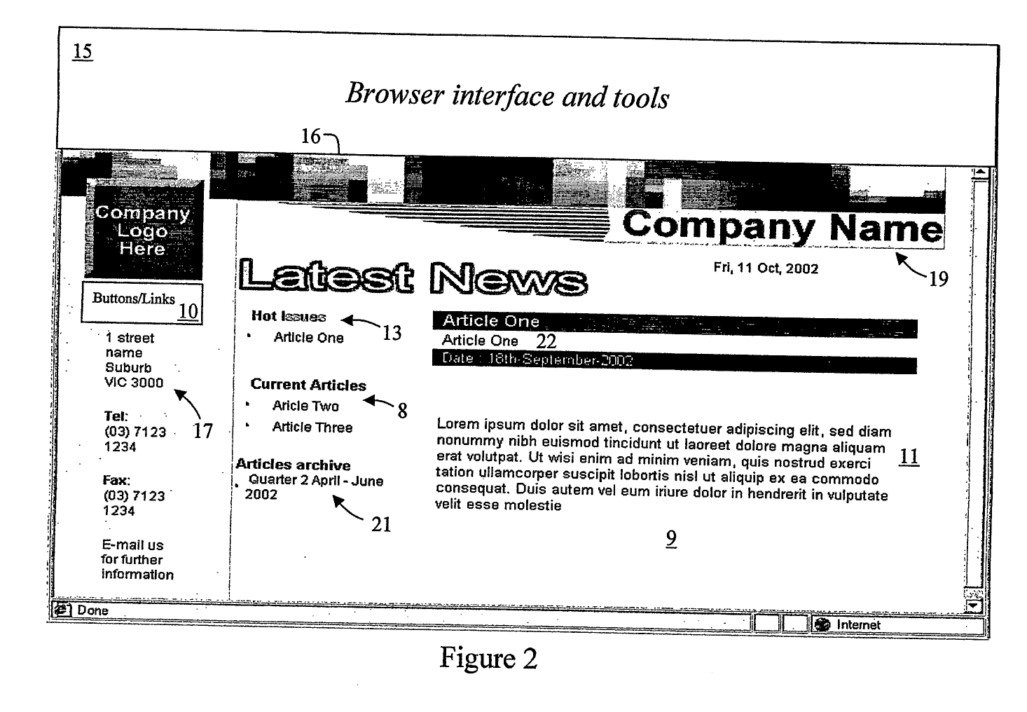

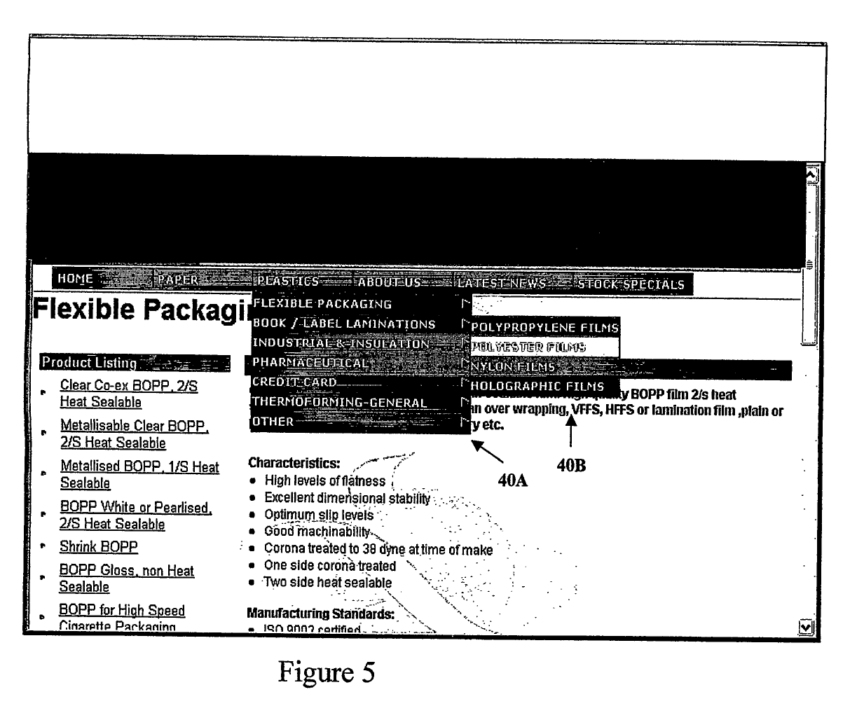

Information is entered into a content module 1 as records into the central database 4 but are seen as ‘articles’ when displayed. If these ‘articles’ become numerous and stretch over a long period of time the web site owner may add a search function that will allow the viewer to search through the articles of a content module. When an ‘article’ is added through the URL based editing tools 6 it is also given its own unique identifier that is matched to the content module identifier of the content module to which it belongs, all being stored in the central database's main client and article tables. A content module 1 can contain a large number of records, and therefore a lot of web site content. FIG. 2, for example, is a view of a web site constructed by means of the apparatus of FIG. 1 using a template (3) page and a content module, and shows how a number of ‘articles’ can be displayed when the relevant content module 1 is loaded by a template (3). Note also in FIG. 2 how ‘articles’ can be categorised 13, 8, or archived 21 after a set period of time, and that the top most record (article) may be automatically opened 22, and 11 when the content module 1 is loaded. FIG. 5 is an example of how a menu system, 40A and 40B, allows many content modules to be attached to a web site for loading when requested.

When an ‘article’ is created it is given a title and when the content module 1 is loaded to a web site all associated titles are usually displayed down the left hand side of the space provided by the site's template 3 giving the viewer a chance to choose what they wish to read by clicking on a title. However, the content of only one article is usually displayed at a time and down the right hand side of the space provided by the site's template 3. This open ‘article’ is usually the first in the list of titles sent to the client when the content module is loaded as it is usually the latest or most important.

When an ‘article’ is added to a content module 1 it is preferably given a date. The system uses this date for archiving purposes and relates it to a set length of time before archiving, a period of time set by the administration tool 12 when the web site owner initially purchases, leases or rents a content module. The content module 1 owner has the ability also to set an article's creation date to whatever they desire. When this period is reached the article in question can be automatically archived. Until a record (article) is deleted it will always be available through the content module 1 it is associated with.

A new or existing web site owner can be added to the central database 4, usually as a result of purchasing, leasing or renting access to one or more content modules 1 for storing their web site content, via the system administration tool 12 that enters their details into a client table within the central SQL or equivalent database when creating the content module 1 in the first place. It does this by assigning each a unique identifier and password.

A web site owner may have contracted access to more than one content module 1 but every module has it's own identifier assigned when created. This identifier is used to manage associated content (articles), for accessing module editing tools, and for when the content module 1 URL is called to a web site.

The content in a content module 1 may be added by the web site owner whenever they feel it is appropriate to do so and can also be altered whenever they feel it's appropriate. The management of records within a content module 1 is carried out by using a URL based editing tool 2, a tool that can be accessed where ever a PC has Internet access. Any changes to content are delivered immediately to the site for display via the template 3. To use the editing tool 2 the web site owner has to login by entering a content module's 1 identifier and password, initially allocated by the system's administration tools 12 when the content module 1 was created, into the appropriate fields when the URL based login screen 6 is displayed in a browser. The identifier and password can be altered by the system administration tools 12. The content module editing tools 2 are where the web site owner can perform such tasks as add, delete, display, prioritise by date, and edit content to make it ready for display in the template 3 when called. Such content management is done primarily within the client and article tables of the associative database 4 and on a content module 1 by content module 1 basis.

A web site developer, either in-house or externally, initially produces a template 3 that creates the basic web site structure into which, when launched, is loaded a content modules 1 that contains the specific content usually defined within the template 3 by a topic such as “Latest News”. Other content modules 1 will be loaded when called if the image template 3 has a mechanism to do so such as a button in a navigation panel or multi-layer menu structure. A site's template 3 includes elements that give the site an image by combining components such as colour, one or more gif files 16, one or more logos, watermark(s) if required, navigational mechanisms such as Buttons 10, the site owner's name 19, a space for loading the content module into, and other sundry items such as an address 17 if desired. If no Home Page is present then the template 3 calls an initial content module 1 for display.

The template 3 typically defines an area of a display 9 into which a content module 1 is loaded for display by the browser software 15 of the client. Typically, to ensure content is loaded properly, the template 3 page will either load the content module into a Frame or run a script such as PHP or PERL.

A web site developed in this manner may include more than one content module and be navigated by use of linking mechanisms such as Buttons 10 or menu system 40. In this case, each Button 10 in the navigation bar or final menu level item 40B, calls another content module to replace the first. An example of multiple content modules is shown in the screen shot of FIG. 5. In general, a Button or menu item may or may not also cause changes within the image template 3 such as a new colour and logo should the Button 10 in question be used, for example, for access to an associated company. In this way all business specific content displayed 9 is a record from the central SQL or equivalent database rather than a stored static html file or database record from the server where the template files are stored, as is the case with a traditional site. It will also be appreciated that the site itself can perform no role on behalf of the web site owner if no content has been added to any associated content modules 1 as no content will be displayed if there is none to display.

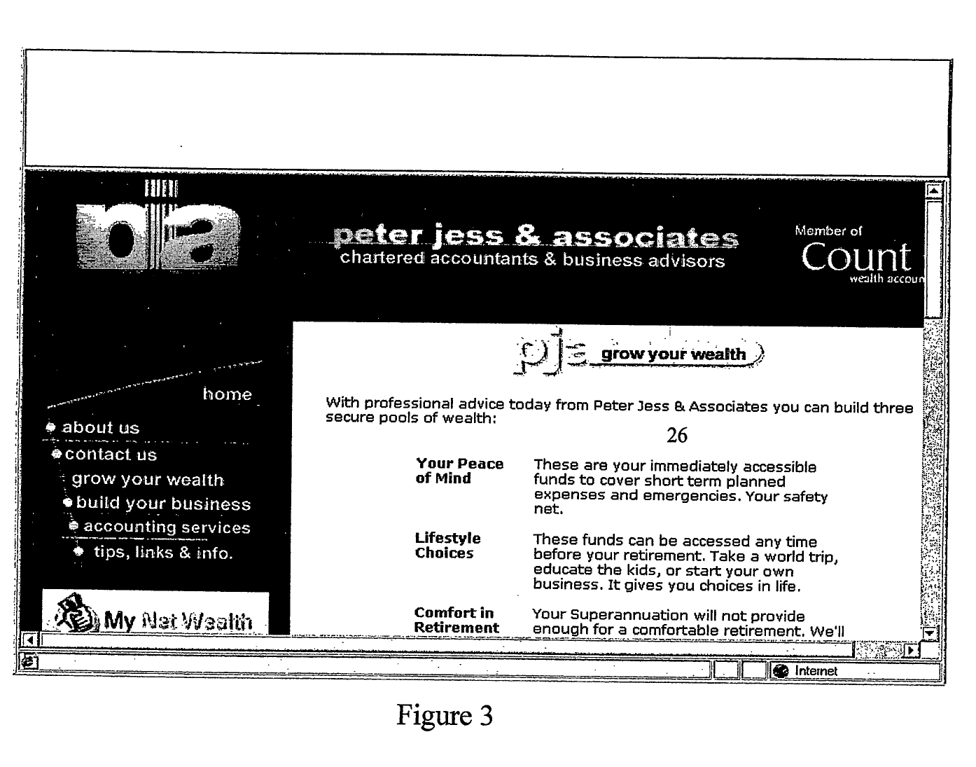

A prior art site is illustrated, by way of distinction, in FIG. 3. In the site shown in FIG. 3, the displayed content 25 is from stored html files and is static in nature 26, that is, the web site owner has no immediate control over it other than by means of costly and time consuming input from a specialist web site expertise using specialist software. It is because of these limitations that such content 25 is very limited in volume, is inflexible, and most significantly, limits—over time—the web site owner's ability to actually use such a site to the company's benefit. Such sites tend to cease being part of a company's marketing strategy (or cease to be updated) soon after their introduction.

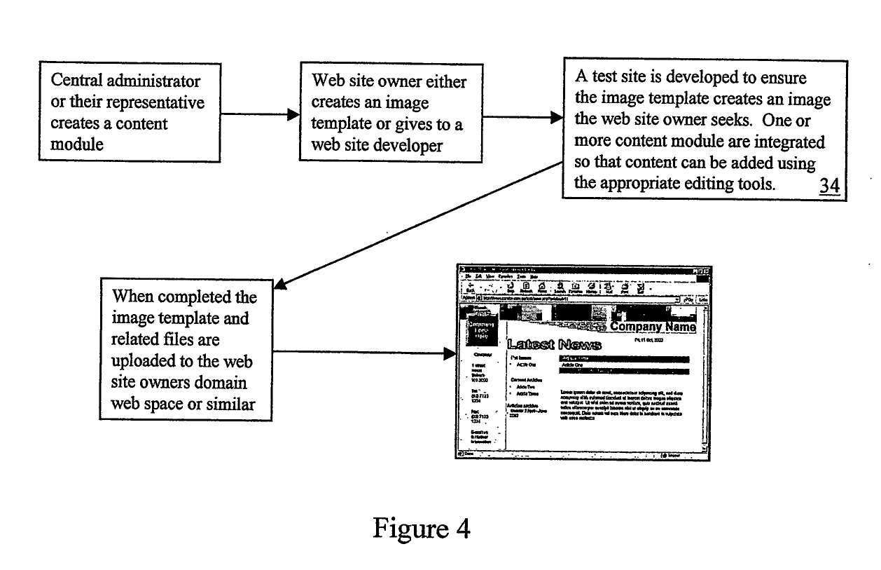

FIG. 4 shows a flow chart of the main steps involved in creating a web site using this preferred method of the present invention, where the system administrator or representative thereof creates a content module 1 and provides the identifier URL to the web site owner for use via a template 3. During this process the developer may have a test site 34 where the web site owner can see what image and ‘look’ is being developed. This test site should also allow the display of the content contained in the content module(s) 1, though the web site owner can start to add content via the secure content module editing tools 2 immediately they have the respective content modules(s) 1 login details.

When a web site has been developed using this method all supporting files such as .gifs, can be uploaded to the web site owner's domain web space 39 or equivalent. Thus, the web site owner's domain space is used for the storage of any extra images and files that are to be loaded into an ‘article’ when the relevant title is selected from a listing in a displayed content module. Such images and files are usually posted to this space by using a standard ftp program when the site owner wishes to use such images and files in one or more ‘articles’. The method of this invention thus requires less domain web space than a conventional web site.

A traditional Home Page and/or a traditional static content page based on a stored html file may be incorporated into a web site developed according to the preferred embodiment of the present invention without compromising the spirit and uniqueness of this invention. That is, the majority of pages will still be formed of content modules.

This method of web site construction of the preferred embodiment is particularly suited to smaller businesses, which are able to gain considerable cost savings and business development benefits by being able to have current staff use a web site as easily as they currently use a word processor. This end is achieved by removal of the need for specialist software and expertise or training. Current problems that are replaced with an ability for quick editing by existing and untrained employees so that products can be taken to market quicker, the costs of sales aids and tools can all but be removed, the need for expertise is gone, and the initial cost of web site development can be considerably lessened.

The preferred embodiment of the present invention enables the construction of a web site based on using web site owner controlled central database records for the supply of content rather than traditional stored html files/records. Records that are stored and managed in a large global SQL or equivalent database but called to individual sites by its image template. The preferred embodiment is particularly suited to having many sites attached to one central database rather than the ‘norm’ of web sites consisting mainly of files/records stored on individual web servers. In particular, this means that only one central database need be maintained for a plurality of web sites. The central database is itself populated by information added by the web site owner and whose data is identifiable by an identifier given when they were initially added to the system. Information records (articles) associated to this identifier and the identifier itself may be termed a content module and by calling this identifier for display via the image template all associated content records, usually known as articles and having their own identifier, are as one supplied to the web site.

All content can be controlled by the web site owner via a secure URL based content module editing tool, then by adding a new or selecting an existing ‘article’ to edit or delete. This tool allows the combination of text, HTML script, images, hyperlinks to other internet based resources, and file types such as PDF, .doc and xis to be used in an article. The content module editing tool requires a content module's User identifier and Password before product, service or business specific content can be added, edited or deleted.

Each content module can be set for either Public access or Private access so that a private Intranet could be added to a site if desired. The latter has a second User identifier and Password set and both are needed for access once the content module is loaded into a site's template. This User identifier and Password are added by the Administration tool either when the content module is originally set up or subsequently on demand by the web site owner.

The content delivered by a public content module should be visible immediately to the viewer while that delivered by a private content module requires the viewer to complete a login procedure before content is displayed. The latter can be used, for example, as an Intranet by the web site owner.

A central database manager uses an administration interface to allocate, establish and otherwise set up each new content module that the image template uses to add content to the finished web site. This mechanism ideally attaches the name of the web site owner and contact details to the module and allocates a unique identifier. It can also control the URL and style sheet file the site can use to load the content module to ensure ‘articles’ are displayed on the client PC as part of the site itself. It is here also that the module can be designated as either public or private. This interface then lists all content modules and allows management functions such as edit, change password, delete, and change Intranet password.

Some advantages associated with implementing a preferred embodiment of the present invention, include:
The system removes the considerable amount of time often wasted while the web site developer waits for content, here a professional site is produced and the web site owner is responsible for adding content themselves.
The system removes the need for expertise with post development content editing which, in turn, promotes far greater use of the web site itself by the owner, making it a more powerful business tool for the web site owner.
The system removes the need for the existing developer/web master layer between the internet and the site owner resulting in much lower ongoing web site costs.
Changes to the content modules editing tools are universal and usually free where as currently such changes are hard to share amongst all clients and are usually a cost to the web site owner.
A web site now has the potential to become a significant component of a business's marketing and sales strategy.
The system also has the potential to realistically remove much of the cost associated with flyer and brochure production, something existing web sites have rarely been able to do.
The system removes the need for any expertise or specialist PC based software so that even the most junior member of staff can now be given the task of running the business's increasingly powerful selling and marketing tool.

These advantages allow smaller businesses especially, for the first time, to start using a web site as a true sales and marketing aid. When this happens sales teams and re-sellers are better empowered than ever before and the savings in areas such as printed brochures and flyers will be considerable

As the present invention may be embodied in several forms without departing from the spirit of the essential characteristics of the invention, it should be understood that the above described embodiments are not to limit the present invention unless otherwise specified, but rather should be construed broadly within the spirit and scope of the invention. Various modifications and equivalent arrangements are intended to be included within the spirit and scope of the invention and appended claims.

The claims defining the invention are as follows:

1. A method of providing a web site comprising:
hosting a web site on a web server, said web site having at least one template page defined by a template, said template defining how content should be assembled into a page by a client's computer and including at least one content identifier corresponding to electronic content stored on a content server;
said web server receiving a request for a template page from a client computer;
said web server responding to said request by sending said template to said client computer;
said client computer ascertaining said content identifier from said template;
said client computer sending a content request to said content server according to said content identifier;
said content server receiving said content request and responding by searching records of said content server to locate content associated with said content identifier and sending said content to said client computer;
said client computer assembling at least one page in accordance with said template and including said content and displaying said page.

2. A method as claimed in claim 1, wherein said content comprises a set of content records stored in database, said records being indexed by said content identifier.

3. 3. A method as claimed in claim 1, wherein said content identifier comprises a URL comprising a first portion corresponding to said content server and a second portion corresponding to said content.

4. A method as claimed in claim 1, wherein said content server formats said content into a portion of mark-up language before sending it to said client computer.

5. A method as claimed in claim 1, further comprising said content server having records for a plurality of web sites, said records being identified by content identifiers unique to the web site to which the content of the records belong.

6. A method as claimed in claim 1, wherein said request is sent in response to a user operating said client computer to select said content.

7. A method as claimed in claim 1, further comprising providing access to said records of said content server belonging to said web site to an administrator of said web site and providing means to enable said administrator to modify said records to thereby modify the content of said web site.

8. A method as claimed in claim 1, comprising providing one or more scripts in said template page to enable communication with said content server.

9. A method as claimed in claim 5, wherein said method is used to provide a plurality of web sites each having at least one template page specific to the web site

10. A method as claimed in claim 1, further comprising providing a template having a plurality of content identifiers corresponding to different sets of content, ascertaining which content identifier relates to the request on the basis of the request and sending the ascertained content identifier to said content server.

11. Apparatus for providing a web site comprising:
a content server; and
a web server hosting a web site, said web site having at least one template page defined by a template, said template defining how content should be assembled into a page by a client's computer and including at least one content identifier corresponding to electronic content stored on a content server, said web server being configured to receive a request for a template page from a client computer and in response to send said template to said client computer;
wherein said content server has records containing electronic content and is configured to receive a request from said client computer for the content associated with said content identifier and in response to search said records to locate said content and send said content to said client computer;
whereby said client computer can assemble at least one page in accordance with said template and including said content and then display said page.

12. Apparatus as claimed in claim 11, wherein said content comprises a set of content records stored in a database, said records being indexed by said content identifier.

13. Apparatus as claimed in claim 11, wherein said content identifier comprises a URL comprising a first portion corresponding to said content server and a second portion corresponding to said content.

14. Apparatus as claimed in claim 11, wherein said content server is configured to format said content into a portion of mark-up language before sending said content to said client computer.

15. Apparatus as claimed in claim 11, further comprising means for providing access to said records of said content server belonging to said web site to an administrator of said web site and providing means to enable said administrator to modify said records to thereby modify the content of said web site.

16. Apparatus as claimed in claim 11, wherein one or more scripts are provided in said template page to enable communication with said content server.

17. Apparatus as claimed in claim 13, comprising a plurality of web servers, each hosting at least one web site, each having at least one template page specific to the web site.

18. Apparatus as claimed in claim 11, wherein said template has a plurality of content identifiers corresponding to different content, and said client sends a content identifier to said content server on the basis of a selection by a user of said client computer.
